(19) United States
(12) Patent Application Publication
(10) Pub. No.: US 2022/0405652 A1
(43) Pub. Date: Dec. 22, 2022

(54) MEETING SET-UP SYSTEM SERVER AND MEETING SET-UP SYSTEM

(71) Applicant: SHARP KABUSHIKI KAISHA, Sakai City (JP)

(72) Inventors: Takashi YAMANAKA, Sakai City (JP); KOHJI KATAMOTO, Sakai City (JP); Katsumi NAKANISHI, Sakai City (JP); Yuriko TERADA, Sakai City (JP); MEGUMI IDO, Sakai City (JP); MASAO SAEDA, Sakai City (JP)

(21) Appl. No.: 17/824,153

(22) Filed: May 25, 2022

(30) Foreign Application Priority Data
Jun. 18, 2021 (JP) 2021-101796

(51) Int. Cl. G06Q 10/02; G06Q 10/10

(52) U.S. Cl. CPC G06Q 10/02; G06Q 10/1095

(57) ABSTRACT

A meeting schedule arranger is connected to a plurality of terminals, a schedule manager that stores and manages schedule information of a plurality of members within a particular organization, and to a meeting room reservation manager that stores and manages reservation information of each meeting room available within the particular organization, and configures a meeting set-up system. On the basis of meeting set-up information sent from an organizer terminal, the meeting schedule arranger obtains, from the schedule manager, unoccupied time information of a participant to participate in the meeting; obtains, from the meeting room reservation manager, unoccupied time information of a meeting room to be used for the meeting; creates a meeting schedule plan from the unoccupied time information thus obtained and displays it on the organizer terminal; and selects the meeting schedule plan by the organizer terminal, thereby allowing reservation of a meeting room.

### BACKGROUND OF THE INVENTION

### Field of the Invention

The present disclosure relates to a meeting set-up system server and a meeting set-up system that sets up reservation of a meeting schedule.

### Description of the Background Art

In scheduling of a meeting, reservation management generally includes obtaining schedule information from each of a plurality of participants, determining meeting time based on the schedule information thus obtained, and reserving equipment such as a meeting room.

Japanese Unexamined Patent Application Publication No. 2000-222446 discloses an operation management assistant system including a schedule reservation/management program to collectively reserve and manage schedules of a plurality of members, and a meeting room reservation/management program to search and extract unoccupied times of a meeting room and set up reservation from them.

In the system in Japanese Unexamined Patent Application Publication No. 2000-222446, the schedule reservation/management program only has a function to collect schedule information of each participant and inform a common unoccupied time period (unoccupied time information). A meeting organizer informed on the unoccupied time information thus have to determine meeting time, then manually search an unoccupied meeting room and reserve a meeting room using a meeting room reservation/management program. This causes a problem in that set-up of reservation of a meeting schedule needs troublesome labor of an organizer.

The present disclosure was made in view of the problem described above, and has an object to provide a meeting set-up system server and a meeting set-up system that allow further reduction of labor of an organizer who sets up reservation of a schedule.

### SUMMARY OF THE INVENTION

To solve the problem described above, a meeting set-up system server that is a first aspect of the present disclosure is a meeting set-up system server that is connectable to a plurality of terminals and sets up reservation of a meeting schedule within a particular organization, where the meeting set-up system server is also connectable to a schedule manager that stores and manages schedule information of a plurality of members within the particular organization, and to a meeting room reservation manager that stores and manages reservation information of each meeting room available within the particular organization, and where on the basis of meeting set-up information sent from an organizer terminal which is one of the plurality of terminals, the meeting set-up system server obtains, from the schedule manager, unoccupied time information of a participant to participate in a meeting; obtains, from the meeting room reservation manager, unoccupied time information of a meeting room matching with a requirement to be used for the meeting; creates a meeting schedule plan from the unoccupied time information thus obtained and presents it on the organizer terminal; and allows reservation of the meeting room according to the meeting schedule plan in accordance with an instruction from the organizer terminal.

Furthermore, to solve the problem described above, a meeting set-up system server that is a second aspect of the present disclosure is a meeting set-up system server that is connectable to a plurality of terminals and sets up reservation of a meeting schedule within a particular organization, where the meeting set-up system server is also connectable to a schedule manager that stores and manages schedule information of a plurality of members within the particular organization, and to a meeting room reservation manager that stores and manages reservation information of each meeting room available within the particular organization, where the meeting set-up system server is capable of inputting meeting set-up information, and where on the basis of the meeting set-up information, the meeting set-up system server obtains, from the schedule manager, unoccupied time information of a participant to participate in a meeting; obtains, from the meeting room reservation manager, unoccupied time information of a meeting room matching with a requirement to be used for the meeting; creates and presents a meeting schedule plan from the unoccupied time information thus obtained; and allows reservation of the meeting room according to the meeting schedule plan in accordance with an instruction to be input after display of the meeting schedule plan.

The configuration described above allows a meeting set-up system server to extract an optimal meeting schedule plan by a single operation with reference to unoccupied time information obtained from a schedule manager and a meeting room reservation manager on the basis of meeting set-up information from an organizer terminal (or input directly from the meeting set-up system server). Moreover, it is possible to reserve a meeting room along with a meeting schedule plan in accordance with an instruction from an organizer terminal (or input directly from the meeting set-up system server). This allows reducing a burden of an organizer in setting up reservation of a meeting schedule.

In addition, the meeting set-up system server described above has the meeting set-up information including a plurality of items provided with precedence, and can be configured to be capable of presenting a meeting schedule plan close to the meeting set-up information in accordance with the precedence when no meeting schedule plan matches with the meeting set-up information.

When no meeting schedule plan matches with meeting set-up information, the configuration described above is capable of presenting a meeting schedule plan compromising on a requirement closely with desire of an organizer by providing precedence for each item of meeting set-up information.

Moreover, the meeting set-up system server described above can be configured so that precedence of each item in the meeting set-up information can be set up freely.

The configuration described above allows an organizer to set up freely precedence corresponding to circumstances (such as property of a meeting).

Furthermore, the meeting set-up system server described above can be configured to include a plurality of precedence set-up modes in which precedence of each item in the meeting set-up information is predetermined, where the precedence of each item in the meeting set-up information is capable of being set by selecting any of the precedence set-up modes.

The configuration described above allows an organizer to select a desired mode among a plurality of precedence set-up modes, thereby simplifying set-up of precedence by the organizer.

Furthermore, to solve the problem described above, a meeting set-up system that is the second aspect of the present disclosure is a meeting set-up system that sets up reservation of a meeting schedule within a particular organization, where the meeting set-up system includes a plurality of terminals, a schedule manager that stores and manages schedule information of a plurality of members within the particular organization, a meeting room reservation manager that stores and manages reservation information of each meeting room available within the particular organization, and the meeting set-up system server described above.

The meeting set-up system server and the meeting set-up system of the present disclosure has effects such as allowing extraction of an optimal meeting schedule plan by a single operation with reference to unoccupied time information obtained from a schedule manager and a meeting room reservation manager, thus providing reduction of a burden of an organizer in setting up reservation of a meeting schedule.

### BRIEF DESCRIPTION OF THE DRAWINGS

FIG. 1 shows an embodiment of the present disclosure, and represents a function block diagram depicting a schematic configuration of a meeting set-up system.

FIG. 2 is a flowchart depicting a procedure of setting up reservation of a schedule using a meeting set-up system of Embodiment 1.

FIG. 3 shows an example of a search criteria set-up screen displayed on an organizer terminal when a schedule adjustment function is selected.

FIG. 4 shows an example of a schedule plan selection screen.

FIG. 5 is a flowchart depicting a procedure of setting up reservation of a schedule using a meeting set-up system of Embodiment 3.

FIG. 6 is a sub-flowchart depicting a procedure of fixing an alternative plan in the flow in FIG. 5.

FIG. 7 shows an example of a schedule plan selection screen presenting alternative plans with a changed requirement of meeting equipment.

FIG. 8 shows an example of a schedule plan selection screen presenting alternative plans with a changed requirement of meeting duration.

FIG. 9 shows an example of a schedule plan selection screen presenting alternative plans with a changed requirement of a term for the date.

FIG. 10 shows an example of a schedule plan selection screen presenting alternative plans with a changed requirement of a participant.

### DESCRIPTION OF THE PREFERRED EMBODIMENTS

### Embodiment 1

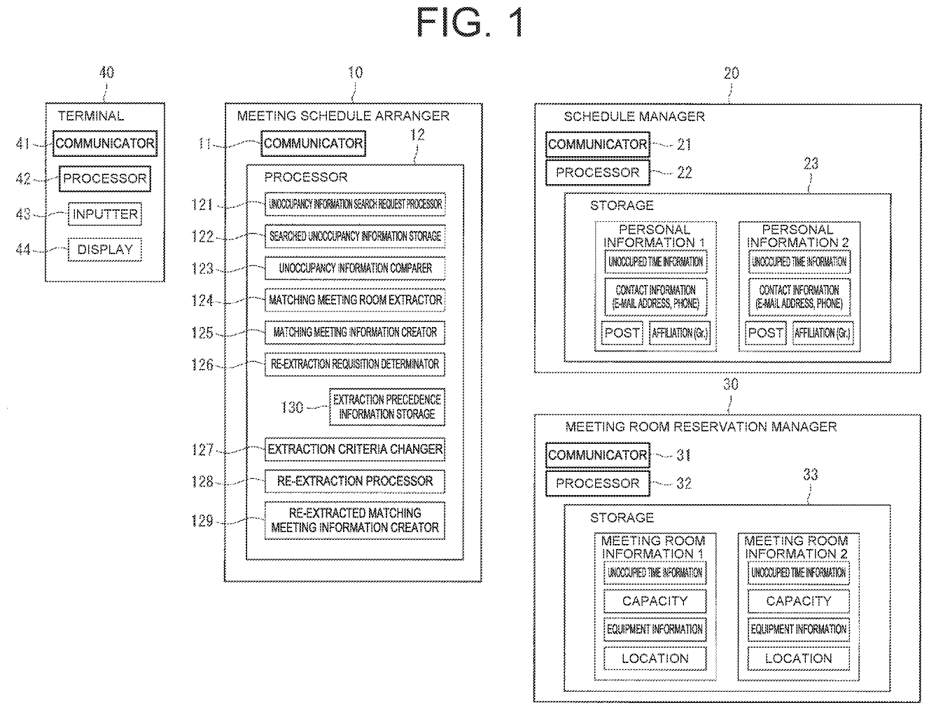

Embodiment of the present disclosure will now be described in detail with reference to the drawings. FIG. 1 is a function block diagram depicting a schematic configuration of a meeting set-up system according to Embodiment 1 (hereinafter referred to as the system). The system is basically used in a particular organization such as a company, and is configured of a server within an organization and a terminal connected via a network to the server. The network to be used is, for example, LAN (Local Area Network).

As shown in FIG. 1, the system has a configuration including a meeting schedule arranger 10, a schedule manager 20, a meeting room reservation manager 30, and a terminal 40. In Embodiment 1, the meeting schedule arranger 10 corresponds to the meeting set-up system server of the present disclosure. The schedule manager 20 and the meeting room reservation manager 30 may be contained in the same server that contains the meeting schedule arranger 10, or in another server communicably connected to the meeting schedule arranger 10. In other words, the schedule manager 20 and the meeting room reservation manager 30 may be contained in the system as parts of the meeting set-up system server, or in the system as externally connected configurations to the meeting set-up system server. In addition, the terminal 40 is a terminal connected to the system via a network, and is a personal computer, a tablet, a smartphone, or the like used by each user. FIG. 1 illustrates the terminal 40 singly, but the system is connectable to a number of the terminals 40.

The meeting schedule arranger 10 includes a communicator 11 and a processor 12. The communicator 11 communicates with the schedule manager 20, the meeting room reservation manager 30, and the terminal 40. The processor 12 sets up a meeting schedule in coordination with the schedule manager 20 and the meeting room reservation manager 30. A particular configuration and operation in the processor 12 will be described later.

The schedule manager 20 includes a communicator 21, a processor 22, and a storage 23. The communicator 21 communicates with the meeting schedule arranger 10 and the terminal 40. The processor 22 performs processing of information writing to and reading from the storage 23. The storage 23 stores schedule information of each member within an organization that uses the system.

The meeting room reservation manager 30 includes a communicator 31, a processor 32, and a storage 33. The communicator 31 communicates with the meeting schedule arranger 10 and the terminal 40. The processor 32 performs processing of information writing to and reading from the storage 33. The storage 33 stores reservation information of a meeting room available within an organization that uses the system.

The terminal 40 includes a communicator 41, a processor 42, an inputter 43, and a display 44. The communicator 41 communicates with the meeting schedule arranger 10, the schedule manager 20, and the meeting room reservation manager 30. The processor 42 performs processing for the inputter 43 and the display 44. The inputter 43 accepts an operational input by a user. The display 44 outputs a display for the user.

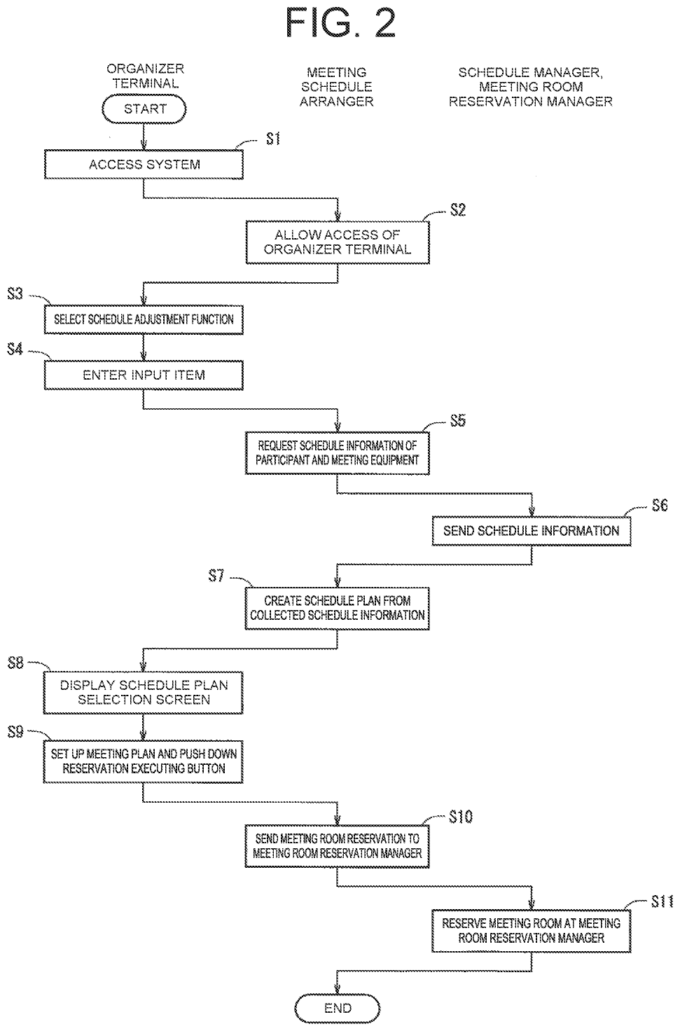

Hereinafter, description will be made for a procedure of setting up reservation of a meeting schedule using the system with reference to the flowchart in FIG. 2.

In setting up reservation of a meeting schedule by the system, an organizer of the meeting first accesses the system (particularly, the meeting schedule arranger 10) from the terminal 40 used by him/herself (hereinafter referred to as an organizer terminal) (S1). Then, once the meeting schedule arranger 10 approves the access of the organizer terminal (S2), the organizer selects a schedule adjustment function (S3).

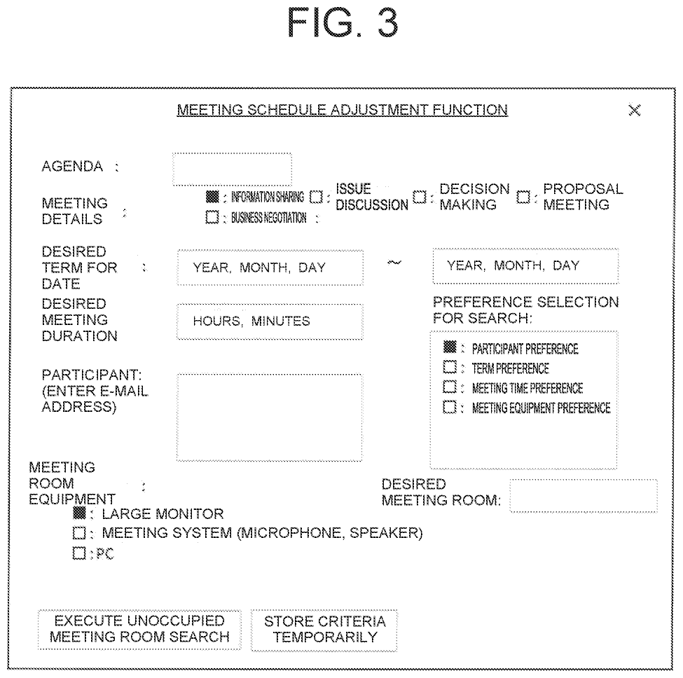

FIG. 3 shows an example of a search criteria set-up screen displayed on the organizer terminal when a schedule adjustment function is selected. The organizer inputs search criteria (meeting set-up information) in the search criteria set-up screen (S4). Particularly, items such as a desired term for the date, desired meeting duration, and a participant of the meeting are input as search criteria. Additionally, in the search criteria set-up screen, other search criteria may be capable of being input such as meeting room equipment (equipment provided in a meeting room), a desired meeting room, and a preferential selection requirement for search, and also, specific information on a schedule to be arranged may be capable of being input such as an agenda or meeting details.

Subsequently, the meeting schedule arranger 10 makes requests for schedule information of a participant, a meeting room, and the like to the schedule manager 20 and the meeting room reservation manager 30 on the basis of search criteria input in the organizer terminal (S5). The schedule manager 20 and the meeting room reservation manager 30 receive the request and transmit schedule information to the meeting schedule arranger 10. In other words, the schedule manager 20 and the meeting room reservation manager 30 extract schedule information matching with the search criteria input in the organizer terminal and transmit it to the meeting schedule arranger 10.

For example, assume that search criteria input by the organizer terminal is as follows:

Participant: Participant A, Participant B, Participant C;

Desired term for the date: August 26 or 27, 9:00-20:00 (except for 12:00-13:00);

Desired meeting duration: 1.5 hours; and

Desired meeting room: Meeting Room A.

In this case, the schedule information requested to the schedule manager 20 is of an unoccupied time period of 1.5 hours or more within a term of August 26 or 27, 9:00-20:00 (except for 12:00-13:00) for Participants A-C. On the other hand, the schedule information requested to the meeting room reservation manager 30 is of unoccupied time period of 1.5 hours or more within a term of August 26 or 27, 9:00-20:00 (except for 12:00-13:00) for Meeting Room A. Note that request commands for schedule information (hereinafter referred to as schedule request) to the schedule manager 20 and the meeting room reservation manager 30 is created by an unoccupancy information search request processor 121 in the processor 12 of the meeting schedule arranger 10.

In the schedule manager 20, the storage 23 stores schedule information of each member within the organization as described above. The schedule information of each member is stored individually for each member as personal information, and each piece of the personal information includes unoccupied time information and contact information, and may further include information on a post, an affiliated group, and the like.

In the schedule manager 20 upon receiving the schedule request, the processor 22 searches the storage 23, extracts unoccupied time information matching with the desired term for the date and the desired meeting duration from personal information of the meeting participants, and transmits it to the meeting schedule arranger 10. Note that although the embodiment has the schedule manager 20 that collectively manages schedule information of each member, the present disclosure is not limited thereto, and that schedule information of each member may be individually managed in the terminal 40 used by each member. In this case, the meeting schedule arranger 10 makes a request for schedule information of the meeting participants to the terminal 40 of each of the participants.

In the meeting room reservation manager 30, the storage 33 stores reservation information (a type of schedule information) of meeting rooms available within the organization as described above. Reservation information of each meeting room is stored individually for each meeting room as meeting room information, and each piece of the meeting room information includes unoccupied time information and capacity, and may further include equipment information, location information, and the like.

In the meeting room reservation manager 30 upon receiving the schedule request, the processor 32 searches the storage 33, extracts unoccupied time information matching with the desired term for the date and the desired meeting duration from meeting room information of the desired meeting room, and transmits it to the meeting schedule arranger 10. Note that when the search criteria informed within the schedule request includes no desired meeting room, a meeting room having capacity exceeding the number of the participants is set to a candidate for reservation, and unoccupied time information for the candidate meeting room has only to be extracted.

The meeting schedule arranger 10 creates a meeting schedule plan (hereinafter referred to simply as a schedule plan) on the basis of the schedule information collected from the schedule manager 20 and the meeting room reservation manager 30 (S7). In other words, an unoccupied time period of 1.5 hours or more is extracted which is common among pieces of the schedule information of all of the participants and the meeting rooms transmitted to the meeting schedule arranger 10. At that time, the schedule information thus collected is temporally stored in a searched unoccupancy information storage 122, and extraction of the unoccupied time period is made by an unoccupancy information comparer 123. Once the unoccupancy information comparer 123 extracts the unoccupied time period, a matching meeting information creator 125 creates a schedule plan for displaying it on the display 44 of the organizer terminal on the basis of the extracted information.

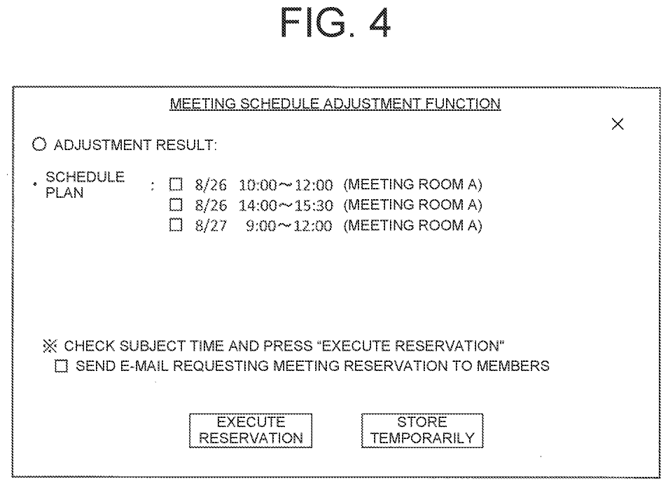

The schedule plan thus created (i.e., the unoccupied time period thus extracted) is transmitted to the organizer terminal, and the organizer terminal displays the schedule plan as a schedule plan selection screen (S8). FIG. 4 shows an example of the schedule plan selection screen. Note that it is preferable that with a plurality of schedule plans, all of the schedule plans be displayed on the schedule plan selection screen to make the organizer select among them as shown in FIG. 4. At that time, the plurality of schedule plans thus displayed is preferably displayed in the order to be capable of being held earlier within the desired term for the date. Furthermore, in the schedule plan shown in FIG. 4, the schedule plans displayed at top and the bottom among the three schedule plans displayed show extraction of unoccupied time periods that are longer than the desired meeting duration (here 1.5 hours). In such case, the organizer may be able to input a meeting reservation time matching with the desired meeting duration on the schedule plan selection screen (for example, input 10:00-11:30 as a meeting reservation time in the schedule plan at the bottom).

The organizer sets up a desired meeting plan (a meeting room and a meeting reservation time) on the schedule plan selection screen (makes a selection from schedule plans displayed), and executes reservation (pushes down a reservation execution button) (S9). At that time, the organizer can also check a check button for sending a reservation requesting e-mail on the schedule plan selection screen, thereby sending a reservation requesting e-mail from the system to each of the participants.

Once the organizer executes reservation, the set-up meeting plan is sent to the meeting schedule arranger 10, and the meeting schedule arranger 10 transmits reservation command of a meeting room to the meeting room reservation manager 30 on the basis of the set-up of the meeting plan (S10). The meeting room reservation manager 30 upon receiving the reservation command reserves the meeting room (updates reservation information of the meeting room in the storage 33) (S11).

If sending of a reservation requesting e-mail is checked on the schedule plan selection screen, the meeting schedule arranger 10 not only transmits a reservation command to the meeting room reservation manager 30, but also transmits a reservation requesting e-mail to the terminal 40 of each of the participants. The reservation requesting e-mail contains meeting plan set-up information, and each of the participants who receive the reservation requesting e-mail can access the schedule manager 20 from the terminal 40 and update his/her own schedule information (input a meeting schedule on the basis of the meeting plan set-up information).

Note that update of schedules of the meeting participants is not limited to performing by the participant him/herself in accordance with the procedure described above, and that the meeting schedule arranger 10 may directly access the schedule manager 20 to automatically update schedule information of each of the participants. In this case, the meeting schedule arranger 10 have only to inform the meeting plan set-up information via e-mail, rather than transmits a reservation requesting e-mail, to the terminal 40 of each of the participants.

As described above, in the system, the meeting schedule arranger 10 can transmit search criteria to the schedule manager 20 and the meeting room reservation manager 30, and obtain from the schedule manager 20 and the meeting room reservation manager 30 schedule information matching with the search criteria. In addition, the meeting schedule arranger 10 can present an optimal schedule plan to the organizer on the basis of the schedule information thus obtained.

In reservation management by the system, the schedule plan displayed to the organizer also includes information on a meeting room to be used, and thus the organizer need not manually search for an unoccupied meeting room, thereby allowing reduction of labor of the organizer.

### Embodiment 2

As has been described so far, in reservation of a meeting room, Embodiment 1 as described above allows inclusion of a desired meeting room into search criteria, extraction of a meeting room to be a candidate for reservation on the basis of capacity of the meeting room, and the like. However, the present disclosure is not limited thereto, and equipment information of a meeting room can also be included into search criteria to extract a meeting room to be a candidate for reservation.

For example, the search criteria set-up screen shown in FIG. 3 enables selection of a large monitor, a meeting system (microphone, speaker), a personal computer, and the like as meeting room equipment. At that time, when the organizer selects a large monitor as equipment required for the meeting, the large monitor is included as equipment information into search criteria. Thus the meeting room to be a candidate for reservation is a meeting room including a large monitor. Information about whether the meeting room has a large monitor is, of course, included in meeting room information stored and managed in the storage 33 (see FIG. 1).

Particularly, when search criteria includes equipment information of a meeting room, a matching meeting room extractor 124 examines accessory equipment of meeting rooms and extracts a meeting room matching with a requirement of accessory equipment desired. For example, when among Meeting Rooms A-C, a large monitor is provided in Meeting Rooms A and B but not in Meeting Room C, inclusion of a large monitor as equipment information into first search information leads to listing only Meeting Rooms A and B as candidates matching with the search criteria. Such extraction of meeting rooms can be made for schedule information stored in the searched unoccupancy information storage 122. After the matching meeting room extractor 124 extracts a meeting room, the matching meeting information creator 125 creates a schedule plan.

### Embodiment 3

Embodiments 1 and 2 described above do not take into account a case where they fail to display any schedule plan matching with search criteria. Nevertheless, in fact, no schedule plan matching with search criteria can also be displayed because of no unoccupied time period common to all participants, of no unoccupied meeting room desired, or the like. In such case, an organizer can also again take into account the property of the meeting and the like, redefine search criteria (such as a requirement of meeting duration, meeting room equipment, or a participant), and repeat the search until a schedule plan is displayed. However, such way is exceedingly troublesome to the organizer.

In the system according to Embodiment 3, precedence is provided in advance for items input on the search criteria set-up screen; when no schedule plan matching with first search criteria succeeds to be displayed, the meeting schedule arranger 10 redefines search criteria based the precedence, re-extracts a schedule plan matching with the redefined search criteria from collected schedule information, and presents it as an alternative plan. This eliminates need for redefining search criteria by the organizer him/herself, thereby allowing further reduction of labor of the organizer.

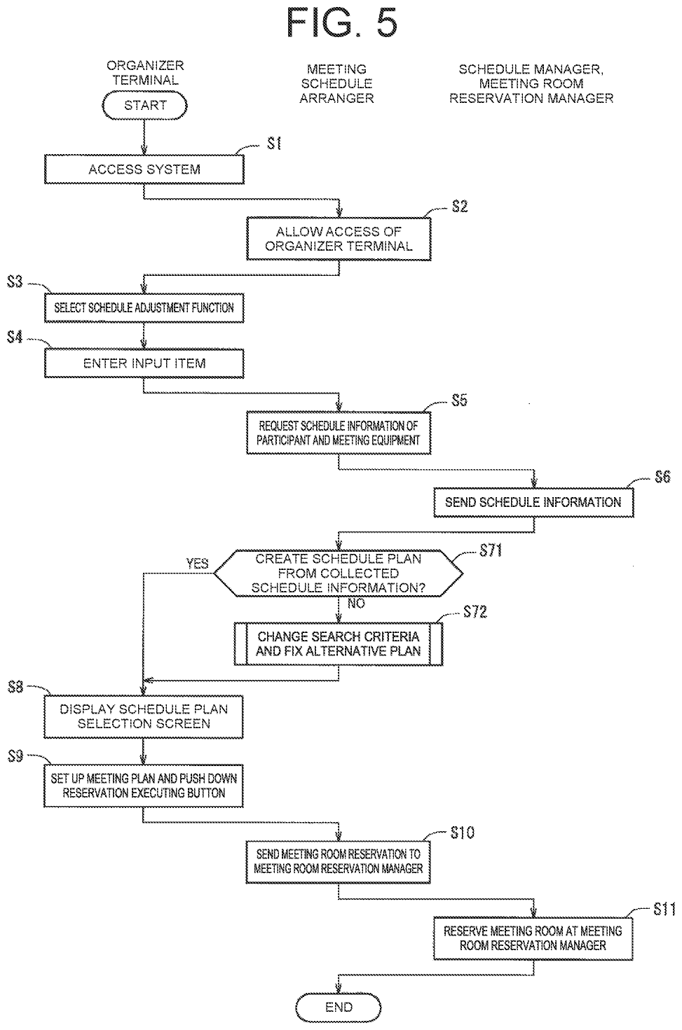

Hereinafter, description will be made for a procedure of setting up reservation of a schedule (meeting) using the system of Embodiment 3 with reference to the flowchart in FIG. 5.

The flowchart in FIG. 5 is almost the same as the flowchart in FIG. 2, but has S71 and S72 substituted for S7 in FIG. 2. At S7 in FIG. 2, the meeting schedule arranger 10 has created a schedule plan based on the schedule information collected from the schedule manager 20 and the meeting room reservation manager 30, but at S71 in FIG. 5, sometimes no schedule plan matches with search criteria, leading to failure to create any schedule plan. When a schedule plan matching with search criteria succeeds to be created (YES at S71), the flow proceeds to S8 as similar to the flow in FIG. 2 and presents the created schedule plan. By contrast, when no schedule plan matching with search criteria succeeds to be created (NO at S71), the search criteria is changed to fix a schedule plan to be an alternative plan (S72). Once the schedule plan to be an alternative plan is allowed to be fixed, the flow proceeds to S8 and presents the schedule plan of an alternative plan.

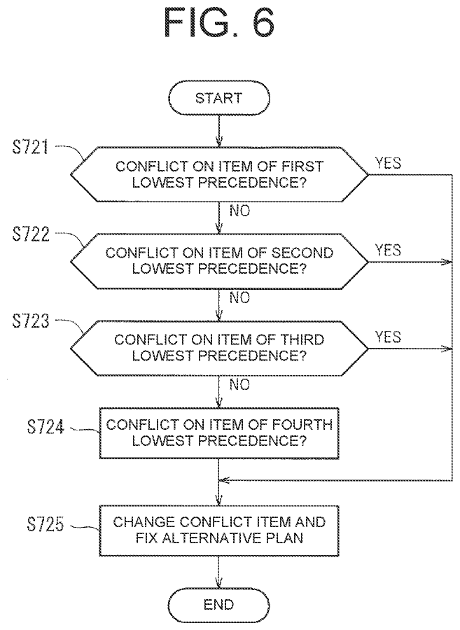

FIG. 6 is a sub-flowchart depicting a procedure of fixing the alternative plan in S72. Note that in the flow in FIG. 6, the search criteria input first include the following four items:

Participant: Participant A, Participant B, Participant C;

Desired term for the date: August 26 or 27, 9:00-20:00 (except for 12:00-13:00);

Desired meeting duration: 1.5 hours; and

Desired meeting equipment: Meeting Room A,

and, have set-up of precedence in the order of a participant, a term for the date, a meeting duration, and meeting equipment (a meeting room or meeting room equipment). Precedence in each item of search criteria can be preferably set-up freely by the organizer on the search criteria set-up screen of the organizer terminal. The set-up precedence is stored in an extraction precedence information storage 130 of the meeting schedule arranger 10 (see FIG. 1).

In the flow in FIG. 6, presence or absence of conflict is checked in the order from an item having lowest precedence (S721-S724). For example, with presence of conflict between items having the second lowest precedence, S721 indicates NO and S722 indicates YES. Additionally, since this case has four items in search criteria, absence of conflict in items having up to the third lowest precedence (NO at S721-S723) represents presence of conflict in the fourth lowest precedence (S724). Note that regarding presence or absence of conflict here, when elimination of a requirement of a certain item yields a common unoccupied time, the item is considered to have conflict. For example, when elimination of a requirement that “desired meeting equipment is Meeting Room A” from search criteria enables presentation of a schedule plan, the item of desired meeting equipment is defined to have conflict. In addition, presence or absence of conflict is determined at the re-extraction requisition determinator 126.

Once S721-S724 reveals an item having conflict, the item having conflict is changed to fix an alternative plan of the schedule plan (S725). For example, a presentation is made for an alternative plan with a changed requirement of an item having the first lowest precedence (meeting equipment, in this case). Change in search criteria (change of an item having conflict) is performed at an extraction criteria changer 127 in the meeting schedule arranger 10 (see FIG. 1). Moreover, creation of an alternative plan based on the changed search criteria is made by a re-extraction processor 128 and a re-extracted matching meeting information creator 129 (see FIG. 1).

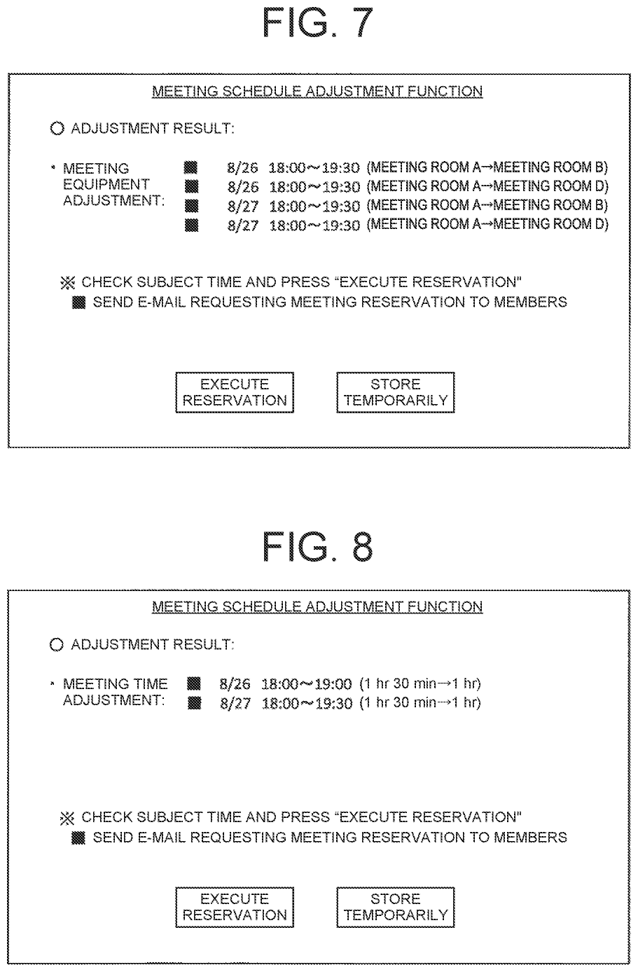

FIG. 7 shows an example of a schedule plan selection screen presenting alternative plans with a changed requirement of meeting equipment. The schedule plan selection screen in FIG. 7 presents four alternative plans, and each of the plans shows items changed from the first search criteria. For example, the first to third plans presented from the top show a change from Meeting Room A, which is desired, to Meeting Room B. Additionally, the second to fourth plans presented from the top show a change from Meeting Room A, which is desired, to Meeting Room D.

FIG. 8 shows an example of a schedule plan selection screen presenting alternative plans with a changed requirement of meeting duration. The schedule plan selection screen in FIG. 8 presents two alternative plans, and each of the plans shows an item changed from the first search criteria. For example, these presented plans show meeting duration shortened and changed from 1.5 hours to 1 hour.

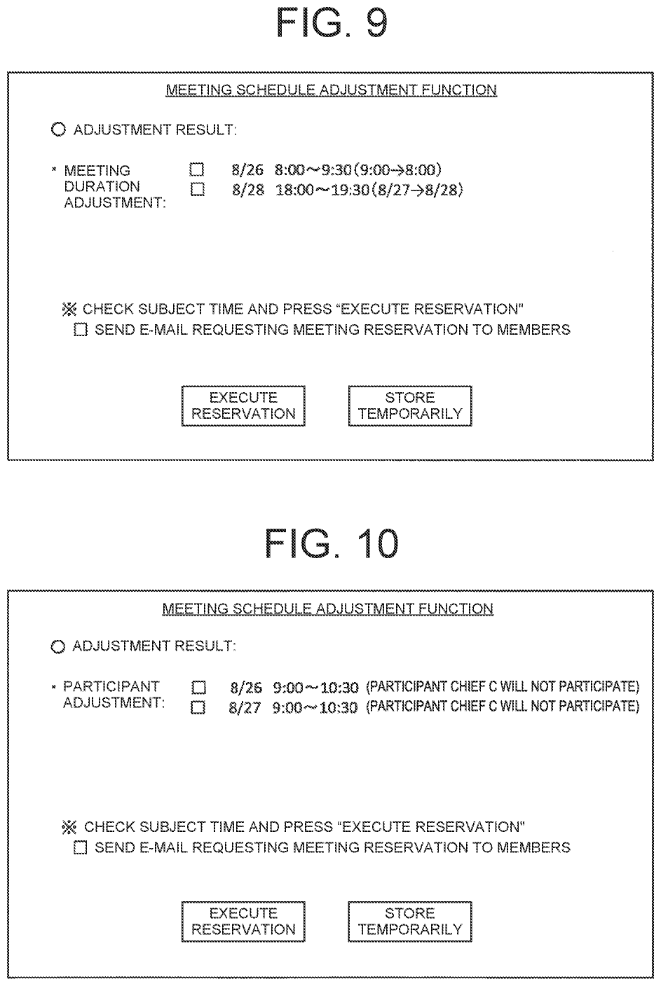

FIG. 9 shows an example of a schedule plan selection screen presenting alternative plans with a changed requirement of a term for the date of the meeting. The schedule plan selection screen in FIG. 9 presents two alternative plans, and each of the plans shows an item changed from the first search criteria. For example, the presented plan at the top shows that starting time of the meeting is changed earlier from 9:00 to 8:00. Meanwhile, the second presented plan shows that the date of the meeting is defined out of the desired term.

FIG. 10 shows an example of a schedule plan selection screen presenting alternative plans with a changed requirement of a participant. The schedule plan selection screen in FIG. 10 presents two alternative plans, and each of the plans show a changed item from the first search criteria. For example, these presented plans show changes in Participant C as not to participate.

Additionally, in the set-up of reservation in Embodiment 3, at S5 and S6 in the flow in FIG. 5, the meeting schedule arranger 10 may collect more schedule information in advance from the schedule manager 20 and the meeting room reservation manager 30 in order to prepare for creation of an alternative plan with change of the search criteria. For example, the example described above shows August 26 or 27 as a desired term for the date in the first search criteria, but schedule information of several days around the date may be collected in order to prepare for change of a term for the date. In this manner, when an alternative plan is created with change of the search criteria, the meeting schedule arranger 10 can avoid requesting re-search in the schedule manager 20 and the meeting room reservation manager 30 on the basis of the changed search criteria. In addition, even when the desired meeting equipment is Meeting Room A, reservation information may be collected for another meeting room.

Furthermore, although precedence in each item of search criteria may be set up freely by the organizer for all items, the present disclosure is not limited thereto, and may employ another set-up method. For example, the system may prepare in advance a plurality of preference modes and compromise modes as precedence set-up modes, among which any mode may be selected, thereby setting up precedence.

For example, the search criteria set-up screen in FIG. 3 prepares four types of preference modes: a participant preference mode, a term for the date preference mode, a meeting duration preference mode, and a meeting equipment preference mode. Assume that precedence of each item in these preference modes is set up as Table 1 below.

TABLE 1

| | Input items | | | |
|---|---|---|---|---|
| | | Term for | Meeting | Meeting |
| | Participant | the date | duration | equipment |
| Participant | 1 | 2 | 3 | 4 |
| preference | | | | |
| Term for the date | 2 | 1 | 3 | 4 |
| preference | | | | |
| Meeting duration | 2 | 3 | 1 | 4 |
| preference | | | | |
| Meeting equipment | 2 | 3 | 4 | 1 |
| preference | | | | |

In such case, for example, when the organizer selects a participant preference mode, precedence is set up in the order of a participant, a term for the date, meeting duration, and meeting equipment. The organizer can select a desired mode among such plurality of preference modes, compromise modes, and the like, thereby simplifying set-up of precedence by the organizer. Moreover, details of preference modes, compromise mode, and the like preparable in the system are not particularly limited, and in addition to the examples described above, the following modes, for example, can also be contemplated:
superior preference mode: prioritize unoccupied time of a person of a superior post among meeting participants;
organizer preference mode: prioritize unoccupied time of a meeting organizer;
term for the date compromise mode: extract an unoccupied meeting room within a predetermined time around a desired term;
meeting duration compromise mode: extract unoccupied meeting time and an unoccupied meeting room with time duration shortened from a predetermined time within a desired term;
meeting equipment compromise mode: if no meeting room is found within a desired term, extract a meeting room preferentially matching with a requirement of meeting room accessory equipment (such as a large display and a TV meeting system) in descending order; and
participant compromise mode: if no meeting room is capable of containing all participants, list each division and ranking of positions corresponding to capacity of a meeting rooms, extract a proposal with a limited number of participants as one person by division, and display contact information of a person unable to participate or present request for participation on a TV meeting system.

The embodiments disclosed herein are illustrative in all points, and are not the basis for limited construal. Therefore, the technical scope of the present disclosure is not construed only by the embodiments described above, and is defined on the basis of recitation in the claims. Moreover, all changes within the mean equivalent to and the scope of the claims are included.

For example, the system described above employs a client-server manner where the meeting schedule arranger 10 is set as a meeting set-up system server. However, the present disclosure is not limited thereto, and can also make an organizer terminal substitute for the meeting schedule arranger 10 (provides an organizer terminal with a function of the meeting schedule arranger 10), thereby setting the terminal as a peer-to-peer connection system. Note that when the organizer terminal is made to substitute for the meeting schedule arranger 10 and set as a peer-to-peer connection system, the organizer terminal corresponds to a meeting set-up system server recited in the claims

What is claimed is:

1. A meeting set-up system server that is connectable to a plurality of terminals and sets up reservation of a meeting schedule within a particular organization,
wherein the meeting set-up system server is also connectable to a schedule manager that stores and manages schedule information of a plurality of members within the particular organization, and to a meeting room reservation manager that stores and manages reservation information of each meeting room available within the particular organization, and
wherein on the basis of meeting set-up information sent from an organizer terminal which is one of the plurality of terminals, the meeting set-up system server obtains, from the schedule manager, unoccupied time information of a participant to participate in a meeting; obtains, from the meeting room reservation manager, unoccupied time information of a meeting room matching with a requirement to be used for the meeting; creates a meeting schedule plan from the unoccupied time information thus obtained and displays the meeting schedule plan to the organizer terminal; and allows reservation of the meeting room according to the meeting schedule plan in accordance with an instruction from the organizer terminal.

2. A meeting set-up system server that is connectable to a plurality of terminals and sets up reservation of a meeting schedule within a particular organization,
wherein the meeting set-up system server is also connectable to a schedule manager that stores and manages schedule information of a plurality of members within the particular organization, and to a meeting room reservation manager that stores and manages reservation information of each meeting room available within the particular organization,
wherein the meeting set-up system server is capable of inputting meeting set-up information, and wherein on the basis of the meeting set-up information, the meeting set-up system server obtains, from the schedule manager, unoccupied time information of a participant to participate in a meeting; obtains, from the meeting room reservation manager, unoccupied time information of a meeting room matching with a requirement to be used for the meeting; creates and displays a meeting schedule plan from the unoccupied time information thus obtained; and allows reservation of the meeting room according to the meeting schedule plan in accordance with an instruction to be input after display of the meeting schedule plan.

3. The meeting set-up system server according to claim 1,
wherein the meeting set-up information comprises a plurality of items provided with precedence, and
wherein the meeting set-up system server is capable of presenting a meeting schedule plan close to the meeting set-up information in accordance with the precedence when no meeting schedule plan matches with the meeting set-up information.

4. The meeting set-up system server according to claim 3,
wherein the precedence of each item in the meeting set-up information can be set up freely.

5. The meeting set-up system server according to claim 4,
comprising a plurality of precedence set-up modes in which precedence of each item in the meeting set-up information is predetermined,
wherein the precedence of each item in the meeting set-up information can be set up by selecting any of the precedence set-up modes.

6. A meeting set-up system that sets up reservation of a meeting schedule within a particular organization, comprising
a plurality of terminals,
a schedule manager that stores and manages schedule information of a plurality of members within the particular organization,
a meeting room reservation manager that stores and manages reservation information of each meeting room available within the particular organization, and
the meeting set-up system server according to claim 1.
